(19) United States
(12) Patent Application Publication
(10) Pub. No.: US 2025/0227082 A1
(43) Pub. Date: Jul. 10, 2025

(54) IMAGE PROCESSING APPARATUS AND CONTROL METHOD

(71) Applicant: CANON KABUSHIKI KAISHA, Tokyo (JP)

(72) Inventor: ASAMI ITO, Kanagawa (JP)

(21) Appl. No.: 19/012,217

(22) Filed: Jan. 7, 2025

(30) Foreign Application Priority Data
Jan. 9, 2024 (JP) 2024-001177

(51) Int. Cl. H04L 51/212; H04L 51/42

(52) U.S. Cl. CPC H04L 51/212; H04L 51/42

(57) ABSTRACT

An image processing apparatus including a scanner includes one or more memories storing instructions, and one or more processors capable of executing the instructions causing the image processing apparatus to manage one or more destinations each with a name in a destination book, perform control to set a subject for an email to which a file including image data generated using the scanner is attached, and transmit the email to a designated destination, wherein the control is performed to set a name of the designated destination as the subject of the email.

### BACKGROUND

### Field of the Disclosure

The present disclosure relates to an image processing apparatus and a method for controlling the image processing apparatus.

### Description of the Related Art

In recent years, workflow automation has progressed. For example, in a case where an email is received, email software automatically filters the email based on preset filtering rules and stores files attached to the email in a desired folder. The email filtering is performed based on subjects and senders. For example, in a case where an email subject includes “invoice”, attached files are stored in an invoice folder. Thus, even in a case where invoices are transmitted from a plurality of sources, the invoices attached to emails are automatically stored in the predetermined folder, enhancing work efficiency. This automatic email filtering function is used by, for example, headquarters personnel in charge of a plurality of stores so that business forms such as invoices and end-of-month application forms transmitted from the stores are filtered automatically.

Devices equipped with email transmission software include multi-function peripherals and electronic blackboards. The devices are capable of transmitting content from scanned image data or an electronic blackboard as an email attachment. For example, multi-function peripherals allow for the registration of a subject to be set uniformly when no subject is designated in an email. Further, an electronic blackboard that allows the automatic setting of an email address or a name of an operator of the electronic blackboard in a subject for email transmission is discussed (refer to Japanese Patent Application Laid-Open No. 2017-112581).

In the above-described environment in which emails are filtered automatically, it is desirable to appropriately filter emails, including emails transmitted from multi-function peripherals or electronic blackboards, based on subjects of the emails. However, the email subject settings in conventional multi-function peripherals or electronic blackboards are not intended for the automatic filtering described above, and it has been challenging to set suitable subjects for the automatic filtering.

### SUMMARY

According to an aspect of the present disclosure, an image processing apparatus including a scanner includes one or more memories storing instructions, and one or more processors capable of executing the instructions causing the image processing apparatus to manage one or more destinations each with a name in a destination book, perform control to set a subject for an email to which a file including image data generated using the scanner is attached, and transmit the email to a designated destination, wherein the control is performed to set a name of the designated destination as the subject of the email.

Further features of the present disclosure will become apparent from the following description of exemplary embodiments with reference to the attached drawings.

### BRIEF DESCRIPTION OF THE DRAWINGS

FIG. 1 is a diagram illustrating a system configuration according to one or more aspects of the present disclosure.

FIG. 2 is a diagram illustrating details of a controller unit of an image processing apparatus according to one or more aspects of the present disclosure.

FIG. 3 is a diagram illustrating a configuration of software executed by the image processing apparatus according to one or more aspects of the present disclosure.

FIG. 4 is a diagram illustrating a filtering rule creation screen of mail software of a client terminal.

FIG. 5 is a diagram illustrating a destination registration sequence of the image processing apparatus according to one or more aspects of the present disclosure.

FIG. 6 is a diagram illustrating a home screen of the image processing apparatus according to one or more aspects of the present disclosure.

FIGS. 7A to 7D are diagrams illustrating a destination registration screen of an image processing apparatus according to one or more aspects of the present disclosure.

FIG. 8 is a diagram illustrating a sequence of email transmission performed by the image processing apparatus according to one or more aspects of the present disclosure.

FIGS. 9A, 9B, and 9C are diagrams illustrating an example of a scan to mail screen of the image processing apparatus according to one or more aspects of the present disclosure.

FIG. 10 is a flowchart illustrating an automatic subject setting process of the image processing apparatus according to one or more aspects of the present disclosure.

FIG. 11 is a diagram illustrating a subject/body setting screen of the image processing apparatus according to one or more aspects of the present disclosure.

FIG. 12 is a diagram illustrating an example of a setting screen of the image processing apparatus according to one or more aspects of the present disclosure.

FIG. 13 is a diagram illustrating an email screen displayed when a received email is opened on the client terminal using the mail software.

FIGS. 14A and 14B are diagrams illustrating a storage screen of the client terminal.

FIGS. 15A, 15B, and 15C are diagrams illustrating a group destination registration screen of an image processing apparatus according to one or more aspects of the present disclosure.

FIGS. 16A and 16B are diagrams illustrating a scan to mail screen of the image processing apparatus according to one or more aspects of the present disclosure.

FIGS. 17A, 17B, and 17C are diagrams illustrating a screen displayed on an image processing apparatus according to one or more aspects of the present disclosure.

FIG. 18 is a flowchart illustrating an automatic subject setting process of the image processing apparatus according to one or more aspects of the present disclosure.

FIG. 19 is a flowchart illustrating an automatic subject setting process of an image processing apparatus according to one or more aspects of the present disclosure.

### DESCRIPTION OF THE EMBODIMENTS

Various exemplary embodiments of the present disclosure will be described below with reference to the drawings. It should be noted that not all features described in the exemplary embodiments are necessarily essential to the solution of the present disclosure. The exemplary embodiments of the present disclosure will describe examples in which an image processing apparatus transmits scanned image data to mail software of a client terminal via a mail server.

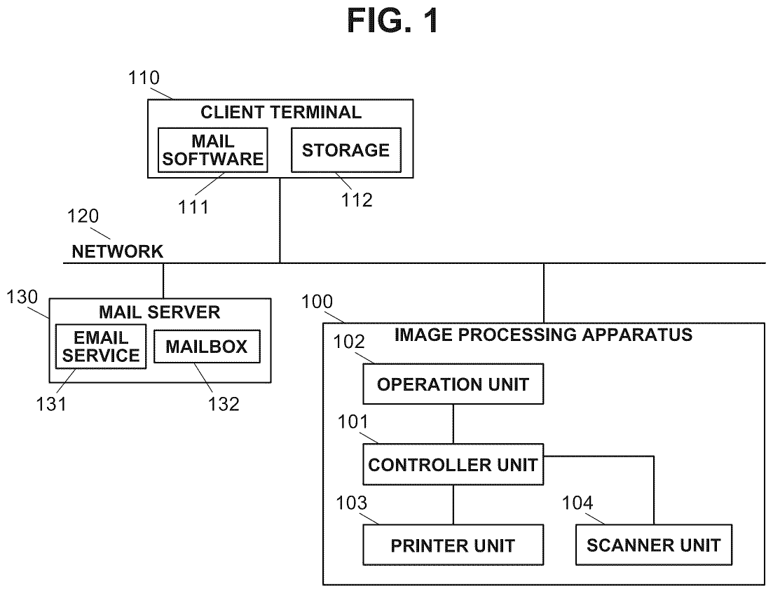

FIG. 1 is a diagram illustrating an example of a configuration of a system according to an exemplary embodiment of the present disclosure.

The system according to the present exemplary embodiment includes an image processing apparatus 100, a client terminal 110, and a mail server 130. The image processing apparatus 100, the client terminal 110, and the mail server 130 are connected via a network 120. According to the present exemplary embodiment, the network 120 may be either a wireless or wired connection.

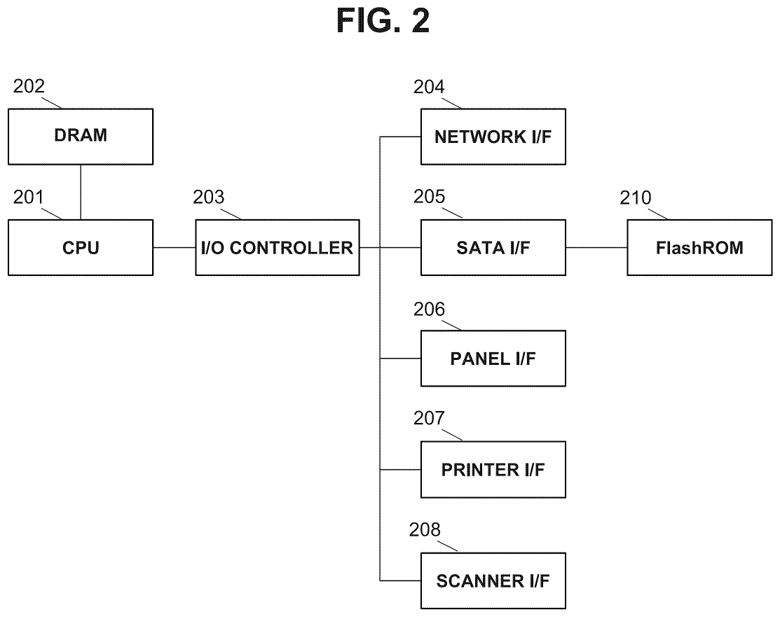

The image processing apparatus 100 reads images from documents using a scanner, prints images using a printer, and performs email transmission and reception via the mail server 130. The image processing apparatus 100 includes an operation unit 102 configured to perform input and output with a user. The image processing apparatus 100 includes a printer unit 103 configured to output electronic data to paper media. The image processing apparatus 100 includes a scanner unit 104 configured to read paper media and convert the read paper media into electronic data. The operation unit 102, the printer unit 103, and the scanner unit 104 are connected to a controller unit 101 and realize functions as a multi-functional peripheral under the control of the controller unit 101. Details of the controller unit 101 are illustrated in FIG. 2 described below.

The client terminal 110 includes mail software 111 and a storage 112. The mail software 111 is software that communicates with the mail server 130 and performs email transmission and reception. The storage 112 is an area used to store data acquired by the client terminal 110. Examples of the client terminal 110 include personal computers (PCs) and tablet terminals.

The mail server 130 includes an email service 131 and a mailbox 132. The email service 131 provides an email transmission function based on the Simple Mail Transfer Protocol (SMTP) defined in Request for Comments (RFC) 5321 upon receiving an instruction from the image processing apparatus 100 or the client terminal 110. Further, the email service 131 provides an email reception function to receive an email stored in the mailbox 132 based on the Post Office Protocol (POP) defined in RFC 5034 or the Internet Message Access Protocol (IMAP) defined in RFC 3501 upon receiving an instruction from the image processing apparatus 100.

FIG. 1 illustrates only the configuration for describing the present exemplary embodiment. It is clear that any other configuration that satisfies the exemplary embodiment of the present disclosure may also be included, and the forms of connection between the components are not limited to those illustrated.

FIG. 2 is a block diagram illustrating an example of details of the controller unit 101 of the image processing apparatus 100.

A central processing unit (CPU) 201 performs primary computational processes in the controller unit 101. The CPU 201 is connected to a dynamic random access memory (DRAM) 202 via a bus. The CPU 201 uses the DRAM 202 as a working memory for temporarily storing program data representing computational instructions during the process of computation by the CPU 201 and process target data.

The CPU 201 is connected to an input/output (I/O) controller 203 via a bus. The I/O controller 203 performs input and output with various devices based on instructions from the CPU 201. A serial advanced technology attachment (SATA) interface (I/F) 205 is connected to the I/O controller 203, and a flash read-only memory (flash ROM) 210 is connected to the SATA I/F 205. The CPU 201 uses the flash ROM 210 to permanently store programs for realizing the functions of the image processing apparatus 100, setting information, and document files. A high-capacity storage device, such as a hard disk drive (HDD), may be connected instead of a flash ROM.

Further, a network interface (I/F) 204 is connected to the I/O controller 203. Wired or wireless local area network (LAN) devices are connected to the network I/F 204. The CPU 201 controls the wired or wireless LAN devices via the network I/F 204 to thereby realize communication on the network 120.

Further, a panel I/F 206 is connected to the I/O controller 203, and the CPU 201 implements input and output for the user through the operation unit 102 via the panel I/F 206.

Further, a printer I/F 207 is connected to the I/O controller 203, and the CPU 201 realizes a paper medium output process using the printer unit 103 via the printer I/F 207.

Further, a scanner I/F 208 is connected to the I/O controller 203, and the CPU 201 realizes a process of scanning images from documents using the scanner unit 104 via the scanner I/F 208.

Various applications for using the functions of the image processing apparatus 100 are present in the image processing apparatus 100. Examples of the applications include copy, transmission, fax, and box functions.

In the case of performing the copy function, the CPU 201 reads program data from the flash ROM 210 via the SATA I/F 205 into the DRAM 202. Based on the on the program read into the DRAM 202, the CPU 201 detects copy instructions from the user through the operation unit 102 via the panel I/F 206. In a case where a copy instruction is detected, the CPU 201 receives a document as electronic data from the scanner unit 104 via the scanner I/F 208 and stores the received electronic data in the DRAM 202. The CPU 201 performs processes, such as color conversion, on the image data stored in the DRAM 202 to make the image data suitable for output. The CPU 201 transfers the image data stored in the DRAM 202 to the printer unit 103 via the printer I/F 207 and performs the process of outputting the image data to a paper medium.

In the transmission function, the CPU 201 detects a transmission instruction from the user using a process similar to that of the copy function. The transmission instruction contains a transmission protocol, a transmission destination designation, and an image format from the user. The transmission protocol is a protocol such as Server Message Block (SMB), File Transfer Protocol (FTP), or email (SMTP). The transmission destination designation is specified using, for example, the Universal Naming Convention (UNC). The image format is a format such as Joint Photographic Experts Group (JPEG) or Portable Document Format (PDF). In a case where a transmission instruction is detected, the CPU 201 receives a document as electronic data from the scanner unit 104 via the scanner I/F 208 and stores the received electronic data in the DRAM 202. The CPU 201 converts the image data stored in the DRAM 202 into the image format designated by the user. The CPU 201 transfers the image data stored in the DRAM 202 to the transmission destination via the network I/F 204 using the protocol designated by the user.

In the fax function, the CPU 201 detects a fax instruction from the user using a process similar to that of the copy function. In a case where a fax instruction is detected, the CPU 201 receives a document as electronic data from the scanner unit 104 via the scanner I/F 208 and stores the received electronic data in the DRAM 202. The CPU 201 converts the image data stored in the DRAM 202 into an image format for fax. The CPU 201 transfers the image data stored in the DRAM 202 to a fax number specified in the fax instruction via a telephone line (not illustrated) to which a fax I/F 209 is connected. The fax through a telephone line is an example, and there may be cases where an Internet fax is employed.

The box function is a function that stores scanned images in a storage area in the image processing apparatus 100 or a memory medium connected to the image processing apparatus 100 and publishes images stored in the image processing apparatus 100 to external PCs (not illustrated) or other image processing apparatuses with the image processing apparatus 100 serving as a file server. In the box function, the CPU 201 detects a box storage instruction from the user using a process similar to that of the copy function. The box storage instruction contains a storage destination designation and an image format from the user. The storage destination is a path to a storage in the image processing apparatus 100 or a memory medium connected to the image processing apparatus 100. The image format is, for example, JPEG or PDF. In a case where a box storage instruction is detected, the CPU 201 receives a document as electronic data from the scanner unit 104 via the scanner I/F 208 and stores the received electronic data in the DRAM 202. The CPU 201 converts the image data stored in the DRAM 202 into the image format designated by the user. The CPU 201 transfers the image data stored in the DRAM 202 to the storage destination designated by the user, such as the flash ROM 210 in the image processing apparatus 100 or a memory medium (not illustrated), via the SATA I/F 205.

In the fax function, a received image may be converted into a format that is viewable on a PC, and the converted image may be stored in the box, instead of printing the image. Further, as the box function, the image processing apparatus 100 serves as a file server, such as an SMB server, and publishes the content of the flash ROM 210. In the box function, the CPU 201 detects an external box access instruction via the network I/F 204. The box access instruction contains an image file path to an access destination. The CPU 201 transfers the image data stored in the flash ROM 210 corresponding to the designated image file path to the source of the box access instruction request via the network I/F 204.

The foregoing functions are an example of the functions of the image processing apparatus 100, and other functions may also be included.

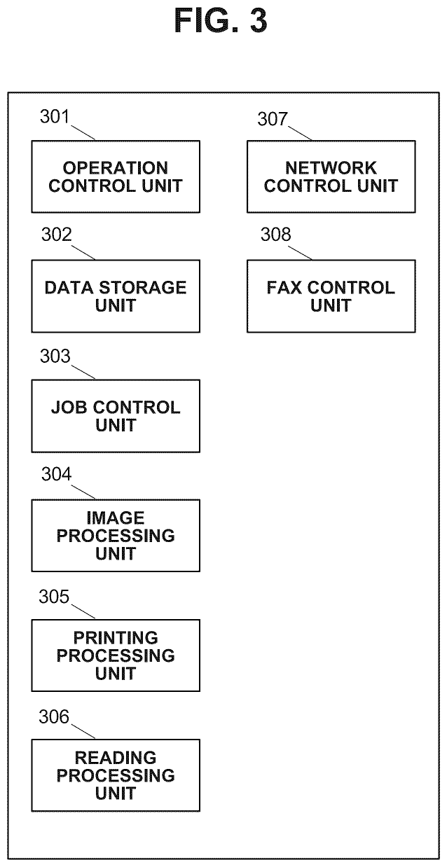

FIG. 3 is a diagram illustrating an example of a software configuration executed by the controller unit 101 of the image processing apparatus 100 according to the present exemplary embodiment. All software executed by the controller unit 101 is executed after the CPU 201 reads the program stored in the flash ROM 210 into the DRAM 202, thereby realizing functional units 301 to 308 illustrated in FIG. 3.

An operation control unit 301 displays screen images for the user on the operation unit 102, detects user operations from the operation unit 102, and performs processes associated with screen items, such as buttons, displayed on a screen.

A data storage unit 302 stores requests and data from the control units in the flash ROM 210 and reads the stored requests and data.

A job control unit 303 controls job execution based on instructions from other control units.

An image processing unit 304 processes image data into a suitable format for each purpose based on instructions from the job control unit 303.

A printing processing unit 305 prints images on paper media via the printer I/F 207 and outputs the paper media based on instructions from the job control unit 303.

A reading processing unit 306 reads set documents via the scanner I/F 208 based on instructions from the job control unit 303.

A network control unit 307 performs data input and output through local area networks (LANs), Wi-Fi, or a public circuit network via the network I/F 204 based on instructions from the control units. Further, the network control unit 307 enables external devices to access data stored in the flash ROM 210 through the network control unit 307 by the data storage unit 302. Examples of data stored in the flash ROM 210 include PDF images and JPEG images.

A fax control unit 308 performs a process of receiving fax data received from the network control unit 307 based on instructions from the job control unit 303, instructs the printing processing unit 305 to print, and stores the fax data in the data storage unit 302 after converting the fax data into a PDF or JPEG image. Further, the fax control unit 308 performs fax data transmission via the network control unit 307 based on the image data read by the reading processing unit 306.

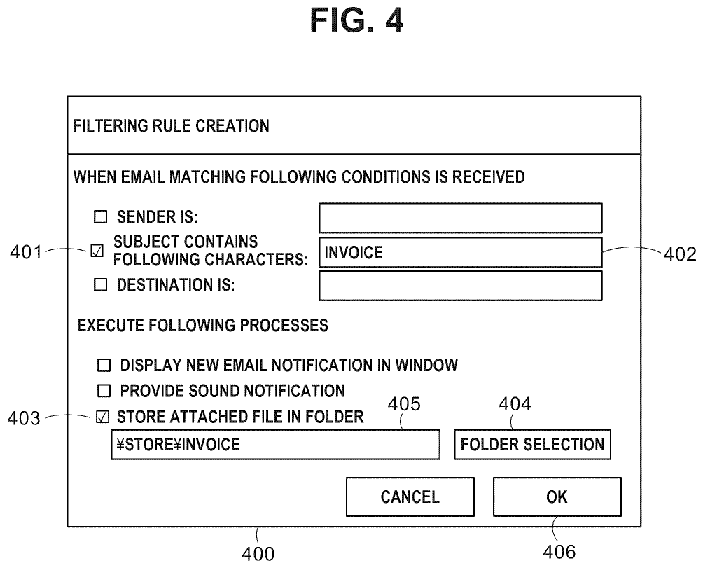

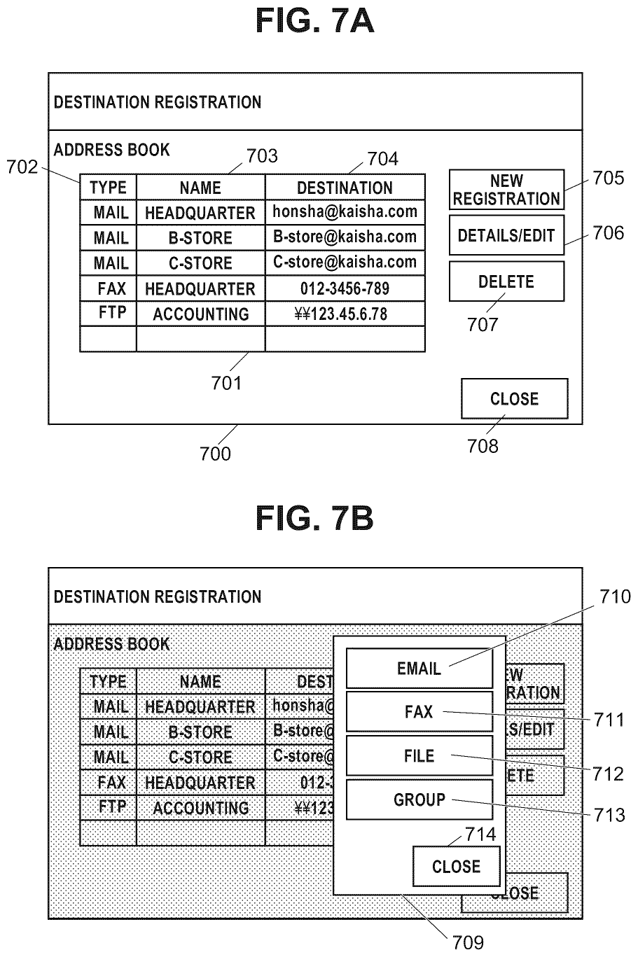

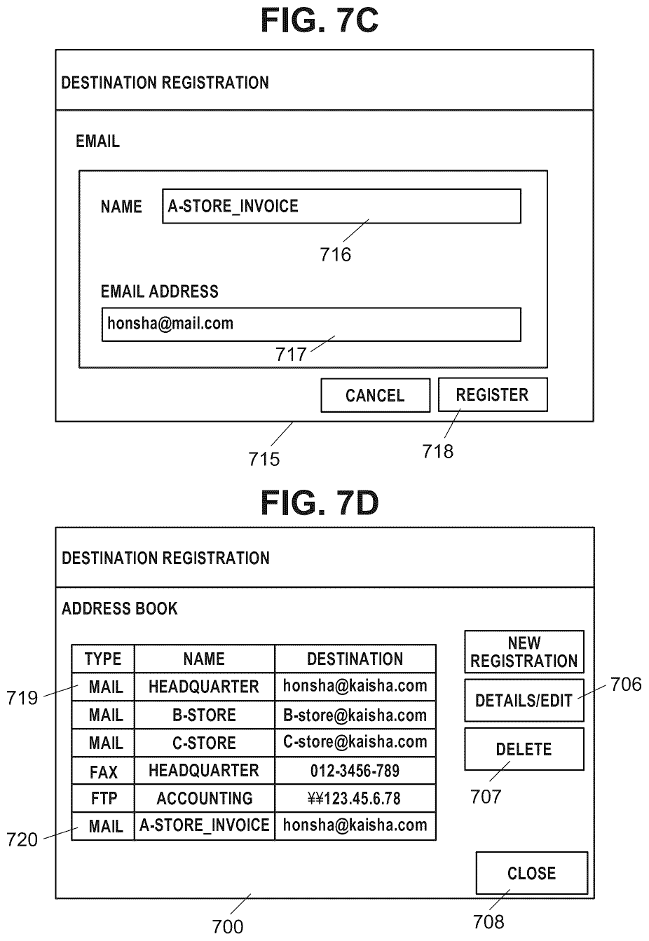

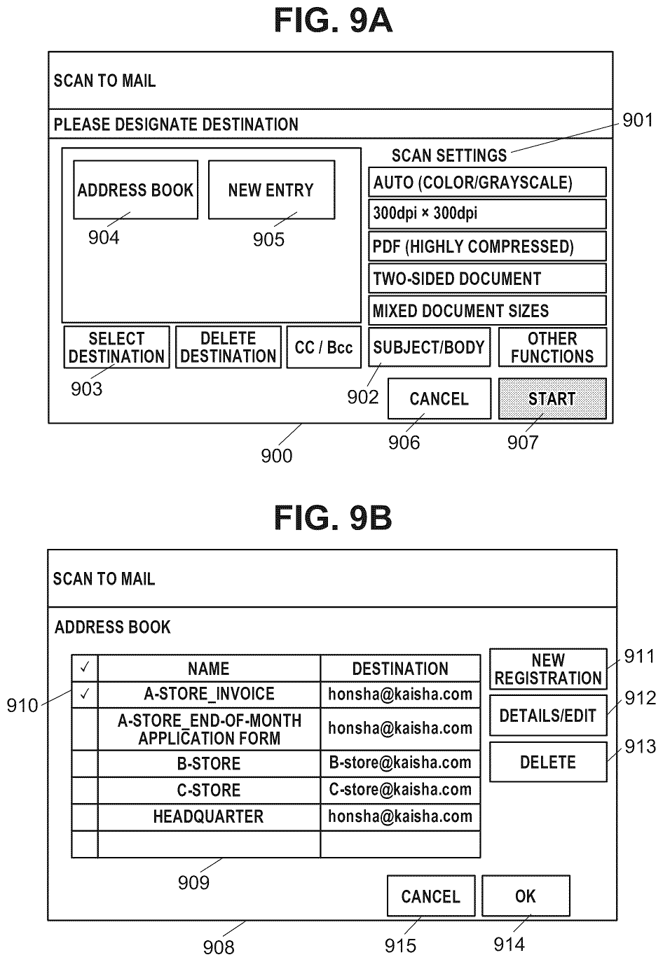

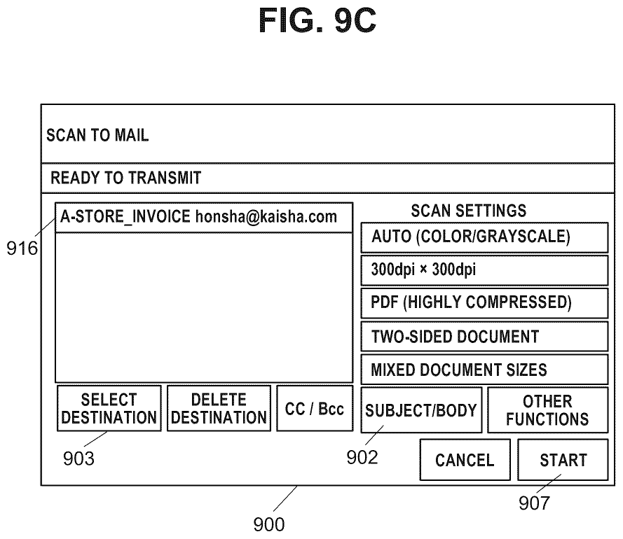

An overview of the operation according to a first exemplary embodiment will be described below with reference to FIGS. 4 to 14. Hereinafter, FIGS. 7A and 7B will collectively be referred to as FIG. 7, and FIGS. 9A and 9B will collectively be referred to as FIG. 9.

FIG. 4 is a diagram illustrating an example of a filtering rule creation screen of the mail software 111 of the client terminal 110.

The mail software 111 of the client terminal 110 allows the setting of filtering rules that can filter received emails and attached data based on arbitrary conditions.

The filtering rules that are configured via the screen illustrated in FIG. 4 will be described below.

In the case of setting filtering rules for incoming emails, first, the user opens a filtering rule creation screen 400 from the mail software 111. For example, in the case of filtering emails that include “invoice” in the subject, the user checks “Subject contains the following characters” in a filtering rule condition 401 and enters “invoice” in a conditional expression 402 on the filtering rule creation screen 400. Further, the user checks “Store attached file in folder” in a process 403 to be executed when an email matching the filtering rule condition 401 is received. In a case where the user presses a folder selection screen 404, a folder selection dialog (not illustrated) is displayed, and the user can select an attached file storage destination. In the example illustrated in FIG. 4, the selected storage destination, “\store\invoice”, is displayed in a file path 405. In a case where the user presses an OK button 406, the rules created via the filtering rule creation screen 400 are registered in the mail software 111, and incoming emails are filtered based on the rules.

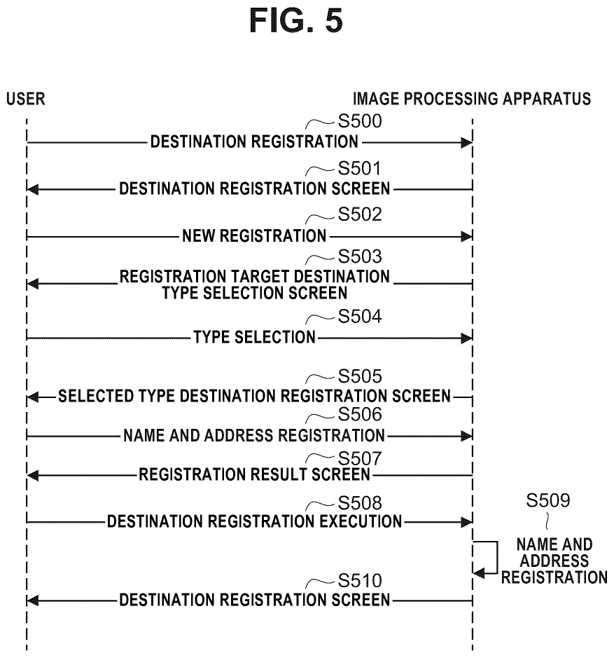

FIG. 5 is a diagram illustrating an example of a destination registration sequence according to the present exemplary embodiment. The processes of the image processing apparatus 100 illustrated in FIG. 5 are executed by the functions realized by the CPU 201 of the image processing apparatus 100 by reading programs stored in the flash ROM 210 into the DRAM 202 and executing the read programs. According to the present exemplary embodiment, information registered as destinations of the image processing apparatus 100, such as names of the destinations, is used as an email subject, so that prior registration of destinations is required. In the following sequence, descriptions of operations during errors that are not essential to the present exemplary embodiment are omitted.

First, when the image processing apparatus 100 is activated, a home screen 600 is displayed on the operation unit 102.

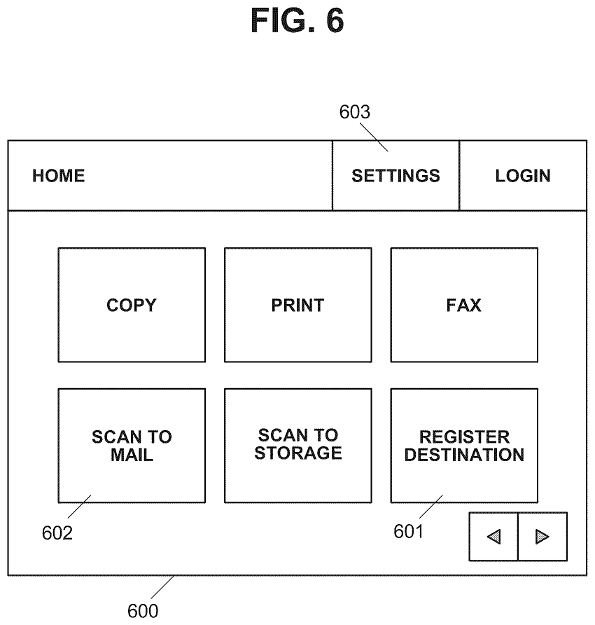

FIG. 6 is a diagram illustrating an example of the home screen 600 of the image processing apparatus 100.

On the home screen 600, buttons for invoking the functions, such as the copy and print functions, are arranged. Further, user authentication may be used. Descriptions thereof are omitted because it is not directly related to the present exemplary embodiment.

In step S500, in a case where a register destination button 601 on the home screen 600 of the image processing apparatus 100 illustrated in FIG. 6 is pressed by the user, the image processing apparatus 100 detects the operation of pressing the register destination button 601. In step S501, in response to the button press, the image processing apparatus 100 displays a destination registration screen 700 illustrated in FIG. 7A on the operation unit 102. A scan to mail button 602 and a settings button 603 on the home screen 600 will be described below.

FIG. 7A is a diagram illustrating an example of the destination registration screen 700 of the image processing apparatus 100.

The destination registration screen 700 displays registered destinations 701 each consisting of a communication protocol type (such as mail, fax, FTP, or SMB) 702, a name 703, and a destination 704.

In step S502, in a case where a new registration button 705 is pressed by the user, the image processing apparatus 100 detects the operation of pressing the new registration button 705. In step S503, in response to the button press, the image processing apparatus 100 displays a destination type selection screen 709 illustrated in FIG. 7B on the operation unit 102.

FIG. 7B is a diagram illustrating an example of the destination type selection screen 709 of the image processing apparatus 100.

The destination type selection screen 709 displays an email button 710, a fax button 711, a file button 712, and a group button 713 as buttons for protocols corresponding to the types of destinations to be registered, and the user selects a protocol corresponding to a type to be registered. In a case where a close button 714 is pressed by the user, the image processing apparatus 100 closes the destination type selection screen 709 and displays the destination registration screen 700 on the operation unit 102.

In step S504, in a case where the email button 710 is pressed by the user, the image processing apparatus 100 detects the operation of pressing the email button 710. In step S505, in response to the button press, the image processing apparatus 100 displays an email destination registration screen 715 illustrated in FIG. 7C on the operation unit 102.

FIG. 7C is a diagram illustrating an example of the email destination registration screen 715 of the image processing apparatus 100.

The email destination registration screen 715 includes fields for registering a name 716 and an email address 717, and in a case where the field of the name 716 or the email address 717 is selected, a software keyboard screen (not illustrated) is displayed so that information can be registered. In a case where another protocol is selected in step S504, a screen for entering required information for the selected protocol, such as a telephone number or a file path, is displayed. Registration is possible even without entering the name 716.

In step S506, in a case where required information is entered in the name 716 and/or the email address 717 by the user, the image processing apparatus 100 detects the operation of entering information in the name 716 and/or the email address 717.

In step S507, the image processing apparatus 100 displays the entered information in the fields of the name 716 and/or the email address 717 in response to the entering of information.

Next, in step S508, in a case where a register button 718 is pressed by the user, the image processing apparatus 100 detects the operating of pressing the register button 718. In step S509, in response to the button press, the image processing apparatus 100 registers the information (hereinafter, referred to as “destination information”) entered in the name 716 and/or the email address 717 to manage the information in a destination book stored in the flash ROM 210. Furthermore, in step S510, the image processing apparatus 100 displays the destination registration screen 700 on the operation unit 102 as illustrated in FIG. 7D. The destination book is stored in the flash ROM 210 and manages one or more destinations (e.g., email address) with a name assigned to each destination.

FIG. 7D is a diagram illustrating an example of the destination registration screen 700 of the image processing apparatus 100.

A destination 719 is a destination with the type “mail”, the name “headquarter”, and the destination “honsha@kaisha.com”. Further, a destination 720 is a destination with the same type and destination as those of the destination 719 but with the name “A-store_invoice” and corresponds to the new destination registered in step S509 in FIG. 5. Specifically, destinations with the same email address but different names can be registered and managed as different destinations in the destination book according to the present exemplary embodiment. According to the present exemplary embodiment, the names of the destinations are used in email subjects. Thus, although different emails are to be transmitted to the same email address “honsha@kaisha.com”, in cases where the destination 719 is selected, “headquarter” is set in the email subject, whereas in cases where the destination 720 is selected, “A-store_invoice” is automatically set in the email subject.

In cases where a details/edit button 706 is pressed by the user, the image processing apparatus 100 displays the email destination registration screen 715 illustrated in FIG. 7C so that the user can check and edit details of the destinations. Further, in cases where a destination is selected and a delete button 707 is pressed by the user, the image processing apparatus 100 deletes the selected destination. Further, in cases where a close button 708 is pressed by the user, the image processing apparatus 100 closes the destination registration screen 700 and returns the display to the home screen 600.

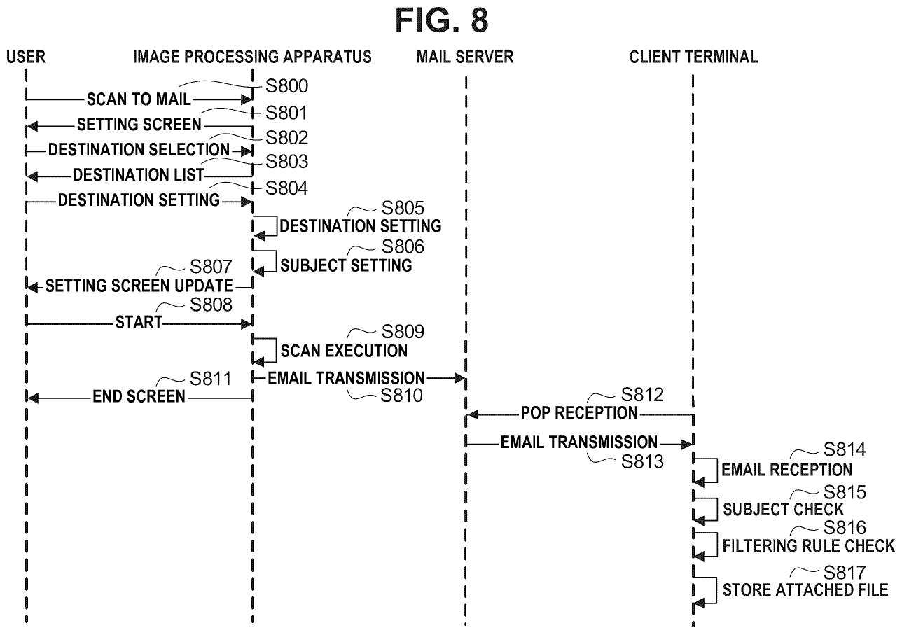

FIG. 8 is a diagram illustrating an example of a sequence of email transmission according to the present exemplary embodiment. The processes of the image processing apparatus 100 in FIG. 8 are executed by the functions realized by the CPU 201 of the image processing apparatus 100 reading programs stored in the flash ROM 210 into the DRAM 202 and executing the read programs. Further, the processes of the mail server 130 are executed by the functions realized by a CPU of the mail server 130 executing the programs. Further, the processes of the client terminal 110 are executed by the functions realized by a CPU of the client terminal 110 executing the programs.

According to the present exemplary embodiment, the user operates the image processing apparatus 100 to transmit scanned image data to the mail software 111 of the client terminal 110 via the mail server 130. The mail software 111 having received an email filters the email based on the filtering rules created as illustrated in FIG. 4. In the following sequence, descriptions of operations during errors that are not essential to the present exemplary embodiment are omitted.

In step S800, in a case where the scan to mail button 602 on the home screen 600 of the image processing apparatus 100 as illustrated in FIG. 6 is pressed by the user, the image processing apparatus 100 detects the operation of pressing the scan to mail button 602. In step S801, in response to the button press, the image processing apparatus 100 invokes the scan to mail function and displays a scan to mail setting screen 900 as illustrated in FIG. 9A on the operation unit 102.

FIG. 9A is a diagram illustrating an example of the scan to mail setting screen 900 according to the present exemplary embodiment.

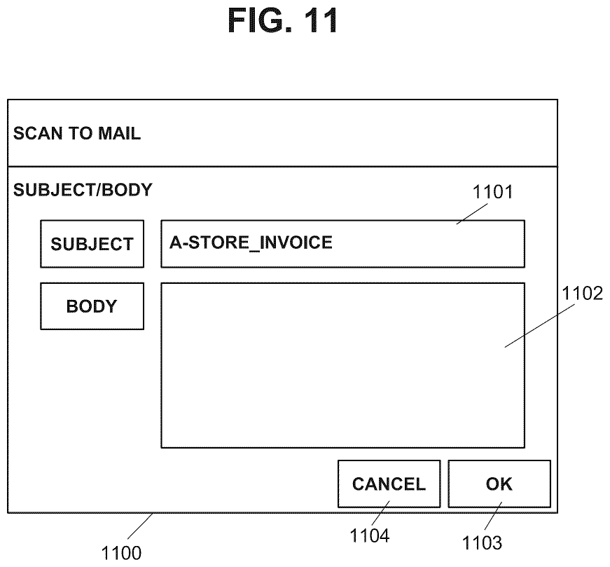

In a case where a start button 907 is pressed by the user, the image processing apparatus 100 transmits electronic data scanned based on scan settings 901 as an email attachment to a destination set by pressing a select destination button 903. The scan settings 901 allow for configuring color and size settings during scanning and may also allow for configuring settings other than those displayed in FIG. 9A. In a state where no destination is selected, the start button 907 is grayed out and cannot be selected. Further, in cases where a cancel button 906 is pressed by the user, the image processing apparatus 100 closes the scan to mail setting screen 900 and returns the display to the home screen 600. Further, in cases where a subject/body button 902 is pressed by the user, the image processing apparatus 100 displays a subject/body setting screen 1100 illustrated in FIG. 11 upon detecting the press operation and receives email subject and body inputs. The subject/body setting screen 1100 will be described below.

FIG. 11 is a diagram illustrating an example of the subject/body setting screen 1100 according to the present exemplary embodiment.

The subject and body of an email to be transmitted can be designated via the subject/body setting screen 1100. In cases where a subject field 1101 or a body field 1102 is pressed by the user, the image processing apparatus 100 displays a software keyboard screen (not illustrated) upon detecting the press operation. The user can enter arbitrary character strings for the subject and body using the software keyboard screen. Further, in cases where an OK button 1103 is pressed by the user, the image processing apparatus 100 stores the character strings entered in the subject field 1101 and the body field 1102 in the DRAM 202 upon detecting the press operation. Further, in cases where a cancel button 1104 is pressed by the user, the image processing apparatus 100 closes the subject/body setting screen 1100 based on the press operation without storing the character strings entered in the subject field 1101 and the body field 1102 and returns the display to the scan to mail setting screen 900.

The description of FIG. 8 will continue below.

Next, in step S802, in a case where the select destination button 903 is pressed and an address book button 904 is further pressed by the user, the image processing apparatus 100 detects the user operations. In step S803, the image processing apparatus 100 displays a destination list screen 908 illustrated in FIG. 9B on the operation unit 102 in response to the user operations. In a case where a new entry button 905 is pressed by the user, the image processing apparatus 100 displays the email destination registration screen 715 on the operation unit 102 in response to the user operation.

The destination list screen 908 displays a destination list 909 of destinations with the communication protocol type 702 that is “mail” among the destinations registered in the image processing apparatus 100. Operations of a new registration button 911, a details/edit button 912, and a delete button 913 are similar to those of the new registration button 705, the details/edit button 706, and the delete button 707, so that descriptions thereof are omitted. Further, in a case where a cancel button 915 is pressed by the user, the image processing apparatus 100 closes the destination list screen 908 in response to the user operation without selecting a destination and returns the display to the scan to mail setting screen 900.

In a case where, for example, a destination 910 with the name “A-store_invoice” and the destination “honsha@kaisha.com” is selected on the destination list screen 908 by the user, the image processing apparatus 100 checks the first column of the table of the destination list 909 in response to the user operation. The user can select a plurality of destinations on the destination list screen 908.

In step S804, in a case where an OK button 914 is pressed by the user with at least one destination being selected, the image processing apparatus 100 detects the user operation. In step S805, in response to the user operation, the image processing apparatus 100 sets the destination selected on the destination list screen 908 as an email transmission destination.

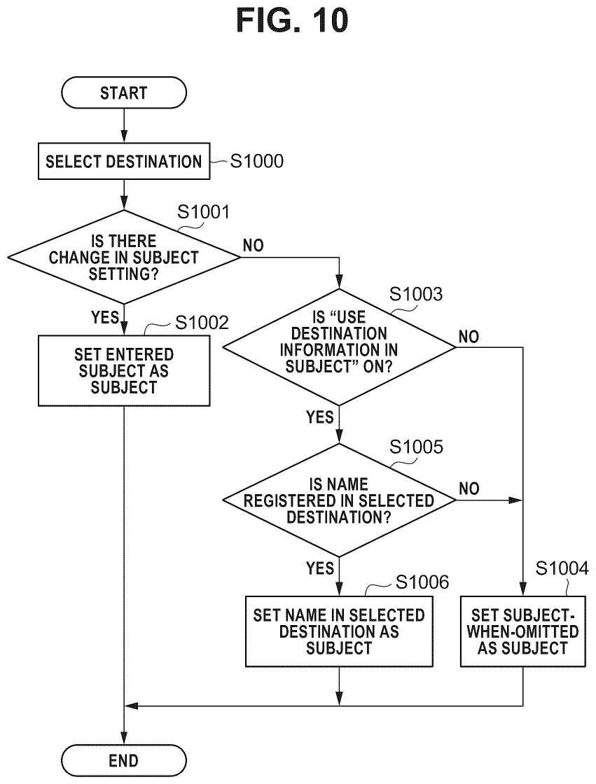

Next, in step S806 (automatic subject setting process), the image processing apparatus 100 sets an email subject based on the destination set in step S805 and the email settings set for the image processing apparatus 100. According to the present exemplary embodiment, the image processing apparatus 100 refers to the settings stored in the image processing apparatus 100, determines a subject for email transmission, and automatically sets the subject. Details thereof will be described below with reference to FIG. 10.

FIG. 10 is a flowchart illustrating an example of the automatic subject setting process according to the first exemplary embodiment. The process illustrated in the flowchart is executed by the functions realized by the CPU 201 of the image processing apparatus 100 reading programs stored in the flash ROM 210 into the DRAM 202 and executing the read programs.

First, in a case where the image processing apparatus 100 is operated and an email transmission destination is selected by the user, in step S1000, the image processing apparatus 100 receives the destination selection operation, and the processing proceeds to step S1001.

In step S1001, the image processing apparatus 100 determines whether a subject has been set by the user (whether there is a change in the subject setting). The subject setting is performed by the user pressing the subject/body button 902 on the scan to mail setting screen 900 and setting the subject on the subject/body setting screen 1100 illustrated in FIG. 11 as described above.

In a case where a subject has been set (there is a change in the subject setting) (YES in step S1001), the processing proceeds to step S1002.

In step S1002, the image processing apparatus 100 sets the arbitrary character string, e.g., “A-store_invoice”, entered in the subject field 1101 as the subject for email transmission, and the process in the flowchart is terminated.

On the other hand, in a case where no subject has been set (there is no change in the subject setting), i.e., in a case where the subject is blank (NO in step S1001), the processing proceeds to step S1003.

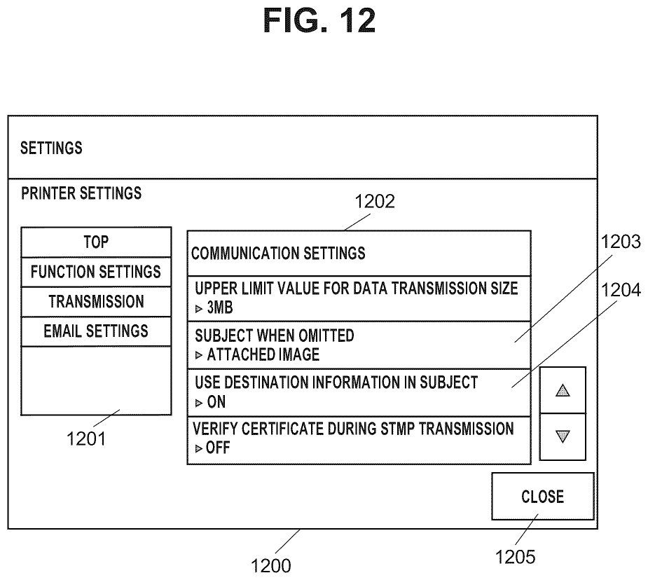

In step S1003, the image processing apparatus 100 determines whether the setting value for “use destination information in subject” is ON. Various settings including “use destination information in subject” are preset by the user using the settings button 603 on the home screen 600. The various settings including “use destination information in subject” will be described below with reference to FIG. 12.

In cases where the settings button 603 on the home screen 600 is pressed by the user, the image processing apparatus 100 displays a setting screen 1200 illustrated in FIG. 12 on the operation unit 102 in response to the user operation.

FIG. 12 is a diagram illustrating an example of the setting screen 1200 according to the first exemplary embodiment.

The setting screen 1200 is a screen via which various settings for the image processing apparatus 100 can be configured. For example, under the settings with a setting path 1201, such as “top/function settings/transmission/email settings”, the user can change the settings by selecting various settings related to email transmission displayed in a field 1202. In the field 1202, an arbitrary character string can be set as a “subject when omitted” in a “subject when omitted” setting 1203. Further, a setting value for “use destination information in subject” can be set to ON (enabled) or OFF (disabled) in a “use destination information in subject” setting 1204. In the example illustrated in FIG. 12, “Attached Image” is set in the “subject when omitted” setting 1203, and “ON” is set in the “use destination information in subject” setting 1204. In a case where a close button 1205 is pressed by the user, the image processing apparatus 100 returns to the home screen 600 in response to the user operation.

The description of step S1003 in FIG. 10 will continue below.

In step S1003, in a case where the setting value for the “use destination information in subject” setting 1204 is OFF (NO in step S1003), the processing proceeds to step S1004.

In step S1004, the image processing apparatus 100 sets the arbitrary character string set in the “subject when omitted” setting 1203 as the email subject. In the example illustrated in FIG. 12, “Attached Image” is set in the “subject when omitted” setting 1203, so that the image processing apparatus 100 sets “Attached Image” in the email subject, and the process in the flowchart is terminated.

On the other hand, in a case where the setting value for the “use destination information in subject” setting 1204 is ON in step S1003 (YES in step S1003), the processing proceeds to step S1005.

In step S1005, the image processing apparatus 100 determines whether a name is registered in the selected destination. In a case where no name is registered in the selected destination (NO in step S1005), the processing proceeds to step S1004.

On the other hand, in a case where a name is registered in the selected destination (YES in step S1005), the processing proceeds to step S1006.

In step S1006, the image processing apparatus 100 sets the name in the selected destination as the email subject. For example, in a case where the selected destination is the destination 910 illustrated in FIG. 9B, since the name of the destination is “A-store_invoice”, the image processing apparatus 100 sets “A-store_invoice” in the email subject, and the process in the flowchart is terminated.

The description of FIG. 8 will continue below.

In step S807, after setting the subject in step S806 as described above, the image processing apparatus 100 updates the scan to mail setting screen 900 as illustrated in FIG. 9C. Consequently, information about the destination 910 selected in step S804 is displayed in a transmission destination list 916 in the table on the scan to mail setting screen 900 in FIG. 9C. In a case where the subject/body button 902 is pressed by the user, the image processing apparatus 100 displays the subject/body setting screen 1100 in response to the user operation. At this time, the subject set in step S806 is reflected in the subject field 1101 of the subject/body setting screen 1100.

In step S808, in a case where the start button 907 on the scan to mail setting screen 900 is pressed by the user, the image processing apparatus 100 detects the user operation. In step S809, in response to the user operation, the image processing apparatus 100 executes a scan based on the scan settings 901, and in step S810, the image processing apparatus 100 transmits scanned data as an attachment to the email to the mail server 130 based on the SMTP protocol. In step S811, after the email transmission is completed, the image processing apparatus 100 displays a transmission completion screen (end screen) (not illustrated) on the operation unit 102 to notify the user of the completion of the transmission.

In step S812, the mail server 130 having received the email from the image processing apparatus 100 receives a POP reception instruction from the mail software 111 of the client terminal 110, and in step S813, the mail server 130 transmits the email to the mail software 111 of the client terminal 110.

In step S814, the mail software 111 of the client terminal 110 receives the email from the mail server 130.

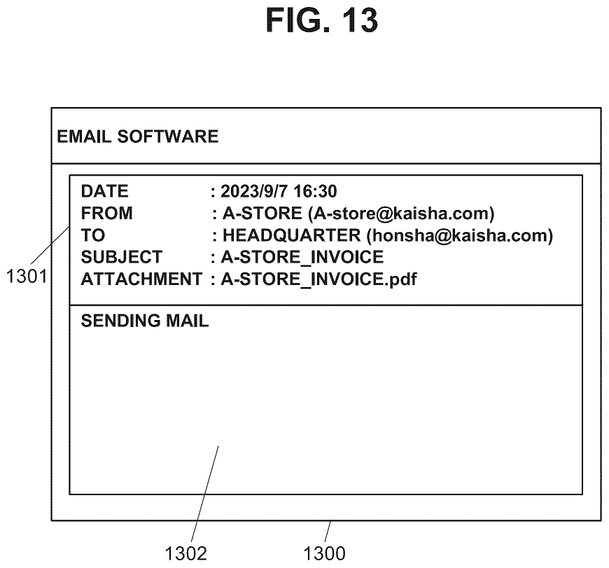

FIG. 13 is a diagram illustrating an example of an email screen 1300 displayed when the email received from the mail software 111 is opened on the client terminal 110.

Email header information 1301 contains the subject (“A-store_invoice” in this example) set in step S806, and a body 1302 is an email body for transmission.

In steps S815 to S817, the mail software 111 filters the email received in step S814 based on the filtering rules set as illustrated in FIG. 4. According to the filtering rules illustrated as an example in FIG. 4, in cases where the subject contains “invoice”, the attached file is stored in the path “\store\invoice” of the storage 112. Thus, in step S815, the mail software 111 checks the subject of the email received in step S814, and in step S816, the mail software 111 checks the filtering rules. Then, in step S817, the mail software 111 matches the subject “A-store_invoice” with the filtering rules and stores (saves) the file attached to the email in the predetermined path.

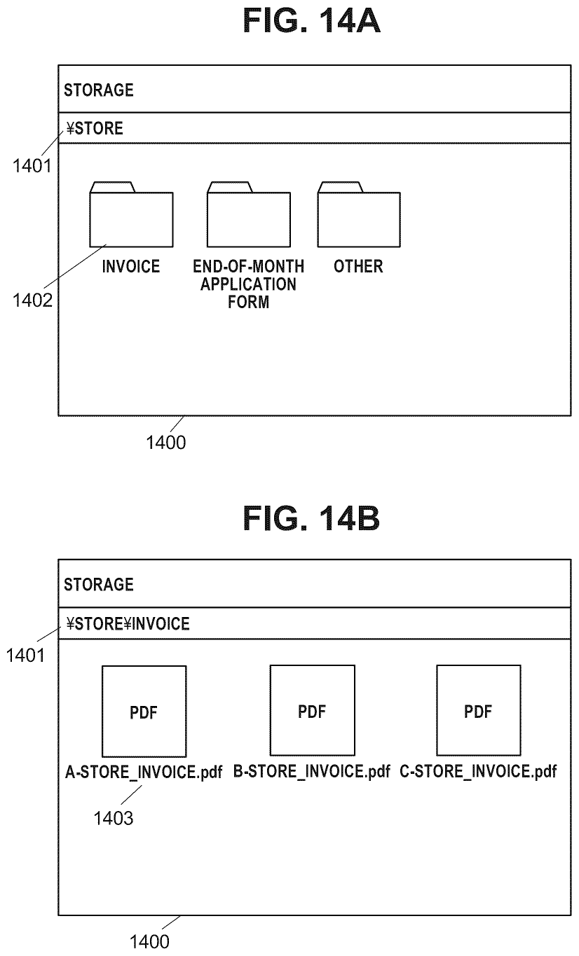

FIGS. 14A and 14B are diagrams illustrating examples of a storage screen 1400 of the client terminal 110.

For example, three folders are in a folder with a folder path 1401 that is “\store” as illustrated in FIG. 14A, and in cases where an “invoice” folder 1402 is pressed by the user, a “\store\invoice” folder illustrated in FIG. 4B is displayed. FIG. 4B indicates that an attached file “A-store_invoice.pdf” 1403 stored automatically through the process in step S817 is stored in the “\store\invoice” folder.

As in the above-described process, according to the first exemplary embodiment, destination information (name is used in the first exemplary embodiment) associated with a destination of an email is automatically set as the subject of the email for transmission of image data scanned and generated by the image processing apparatus 100 via email. In the destination book according to the present exemplary embodiment, different names can be associated with a single email address and registered as different destinations. Thus, the user can easily set an arbitrary subject by simply selecting a destination for email transmission, making it possible to easily support filtering performed by the mail software 111 at the receiving end. For example, in the case of setting different subjects, such as “ . . . invoice”, “ . . . application form”, and “ . . . report”, destinations with information including “invoice”, “application form”, or “report” in the names are registered in advance, whereby a subject is set automatically simply by selecting a destination for email transmission. Thus, unlike conventional technologies, the user does not have to input a subject each time the user transmits an email, making it possible to significantly reduce the burden on the user and enhance usability.

A second exemplary embodiment will be described below with reference to the drawings. It should be noted that not all features described in the exemplary embodiments are necessarily essential to the solution of the present disclosure. The present exemplary embodiment describes an example of transmitting image data scanned by the image processing apparatus 100 to the mail software 111 of the client terminal 110 via the mail server 130. Descriptions of components similar to those in the first exemplary embodiment are omitted.

The first exemplary embodiment describes an example in which a destination name is automatically set as an email subject for email transmission using names registered for individual destinations (the same email addresses with different names are managed as different destinations). The second exemplary embodiment describes an example in which a group destination name is automatically set as a subject in the case of transmitting emails with the same subject to a plurality of destinations simultaneously. The group destination allows for the registration of a plurality of destinations as a single group destination, regardless of protocol types. Specifically, a group including a plurality of destinations can be managed with a name in the destination book. In the present exemplary embodiment, only a plurality of destinations with the protocol “mail” is selected to form a group destination.

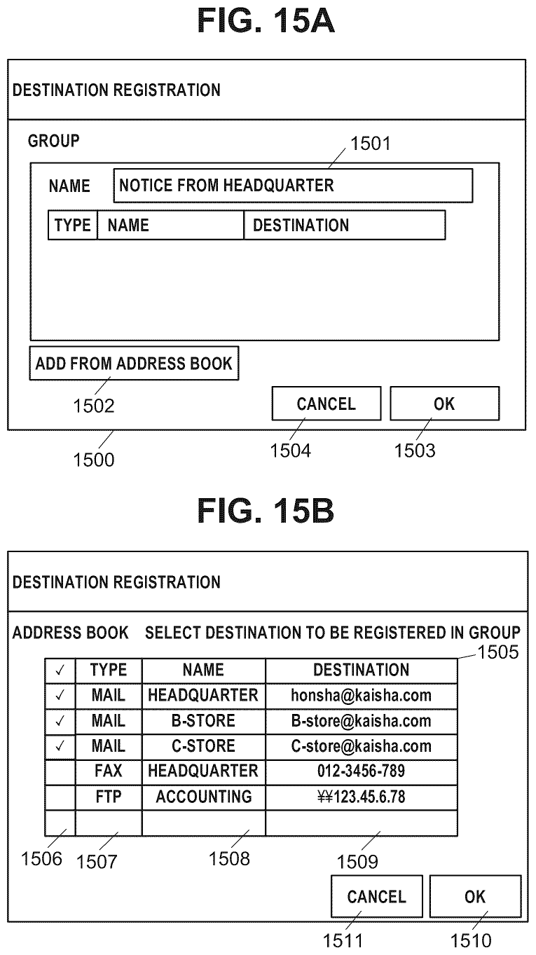

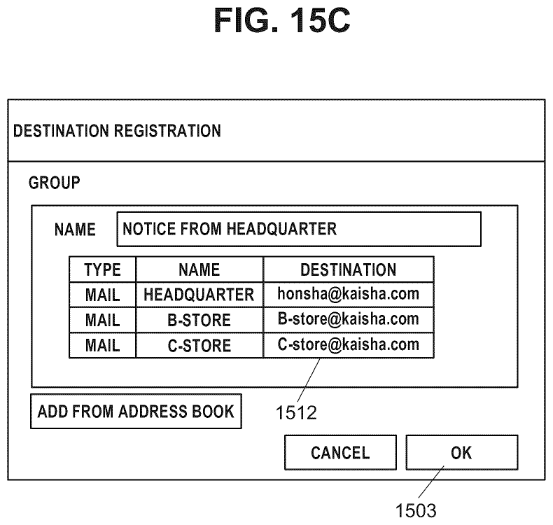

First, the registration of a group destination will be described below with reference to FIGS. 15A and 15B.

FIGS. 15A and 15B are diagrams illustrating examples of a group destination registration screen 1500 during registration of a new group destination in the image processing apparatus 100 according to the second exemplary embodiment. Especially, FIG. 15A illustrates a screen that is displayed on the operation unit 102 of the image processing apparatus 100 in cases where the group button 713 on the destination type selection screen 709 is pressed by the user during destination registration.

On the group destination registration screen 1500, a group destination name 1501 can be set as desired by the user. In the example illustrated in FIG. 15A, “notice from headquarter” is set. In cases where a cancel button 1504 is pressed by the user at this time, the image processing apparatus 100 closes the group destination registration screen 1500 without registering the group destination and returns to the destination registration screen 700. Further, in cases where an add-from-address-book button 1502 is pressed by the user, the image processing apparatus 100 displays a destination list 1505 of destinations registered in the address book on the operation unit 102 as illustrated in FIG. 15B.

The destination list 1505 displays a field 1506 for selecting destinations to be registered as a group destination, a protocol type 1507, a name 1508, a destination 1509.

In the example illustrated in FIG. 15B, three destinations with “mail” and “headquarter”, “B-store”, or “C-store” in the name 1508 are selected as a group destination from the destination list 1505 by the user.

In cases where a cancel button 1511 is pressed by the user, upon detecting this user operation, the image processing apparatus 100 closes the destination list 1505 without holding the selected destinations and returns the display to the group destination registration screen 1500.

Further, in cases where an OK button 1510 is pressed by the user, upon detecting this user operation, the image processing apparatus 100 registers the destinations selected as a group destination and returns the display to the group destination registration screen 1500 illustrated in FIG. 15C.

In the example illustrated in FIG. 15C, the three mails registered as a group destination are displayed in a group destination list 1512. In cases where an OK button 1503 is pressed by the user at this time, upon detecting this user operation, the image processing apparatus 100 registers the group destination using the information displayed in FIG. 15C and returns the display to the destination registration screen 700.

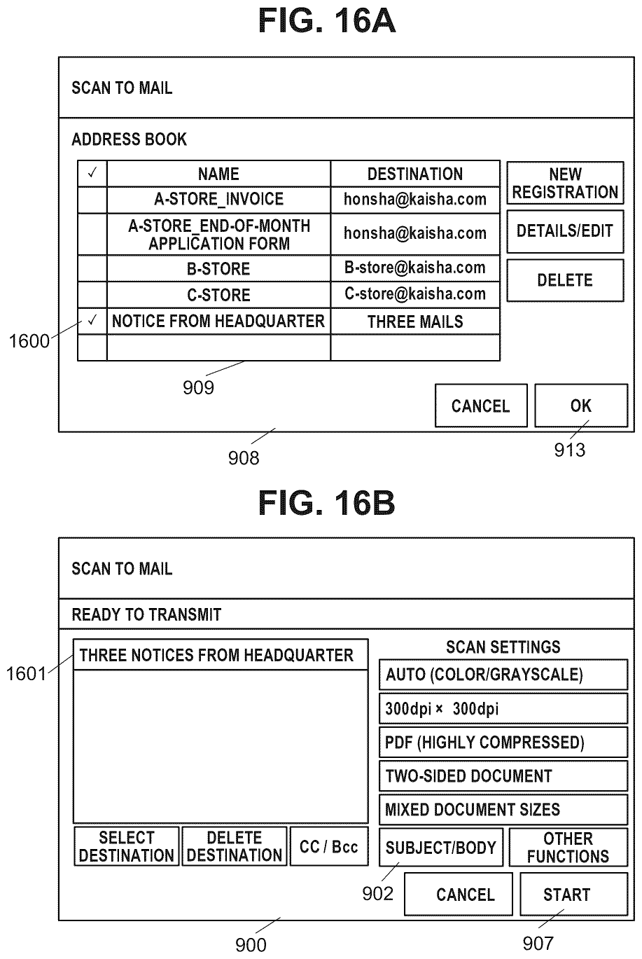

Next, operations in the case of selecting a group destination and transmitting an email will be described below with reference to FIGS. 16A and 16B.

FIG. 16A is a diagram illustrating an example of the destination list screen 908 displayed on the image processing apparatus 100 in step S803 in FIG. 8 according to the second exemplary embodiment.

In this example, a group destination is selected, and a uniform subject is automatically set for the plurality of email destinations. Then, emails are transmitted. In this case, the user selects a group destination 1600 and presses the OK button 914. Upon detecting this operation (step S804 in FIG. 8), the image processing apparatus 100 sets the destinations selected on the destination list screen 908 as email transmission destinations in step S805. Then, the image processing apparatus 100 sets the subject (“notice from headquarter” in the example illustrated in FIG. 16A) for the destinations set in step S805 as the email subject (subject setting in step S806). Details of the subject setting process in step S806 are similar to those in the first exemplary embodiment, so that descriptions thereof are omitted. After setting the subject as described above, the image processing apparatus 100 updates the scan to mail setting screen 900 as illustrated in FIG. 16B in step S807.

Information about the group destination 1600 selected by the user in step S804 is displayed in a transmission destination list 1601 on the scan to mail setting screen 900 by the image processing apparatus 100. At this time, the name “notice from headquarter” and the number of destinations “three” are displayed. Alternatively, other information may be displayed. In cases where the subject/body button 902 is pressed by the user at this time, in response to this operation, the image processing apparatus 100 displays the subject/body setting screen 1100 illustrated in FIG. 11 on the operation unit 102. At this time, the subject “notice from headquarter” set in step S806 is reflected in the subject field 1101 on the subject/body setting screen 1100.

The foregoing configuration automatically sets destination information (“name” is used in the present exemplary embodiment) about the group destination as the email subject for transmission of image data scanned and generated by the image processing apparatus 100 via email, whereby the same desired subject is easily set for the plurality of destinations. Specifically, the user can easily set the desired subject for the plurality of destinations simply by selecting the group destination for email transmission, making it possible to easily support filtering performed by the mail software 111 at the receiving end. Thus, unlike conventional technologies, the user does not have to input a subject each time the user transmits an email, making it possible to significantly reduce the burden on the user and enhance usability.

A third exemplary embodiment will be described below with reference to the drawings. It should be noted that not all features described in the exemplary embodiments are necessarily essential to the solution of the present disclosure. The present exemplary embodiment describes an example of transmitting image data scanned by the image processing apparatus 100 to the mail software 111 of the client terminal 110 via the mail server 130. Descriptions of components similar to those in the first exemplary embodiment are omitted.

The first exemplary embodiment describes an example in which each destination is registered with a name during destination registration and a destination name is automatically set as a subject for email transmission. The third exemplary embodiment describes an example in which each destination is registered with a subject for email transmission separately from the destination name during destination registration and the subject with which the destination is registered is automatically set as the email subject for email transmission.

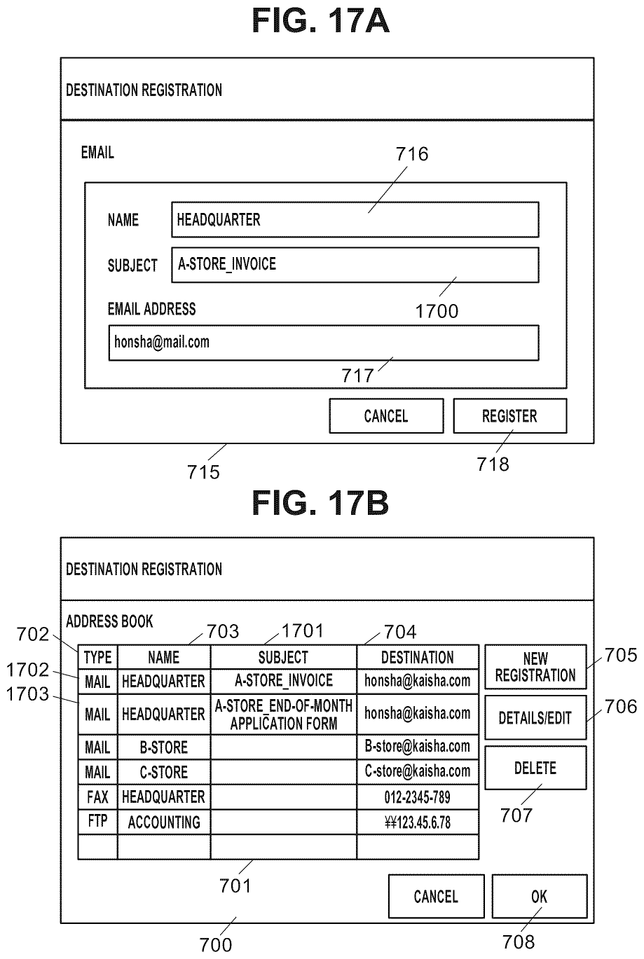

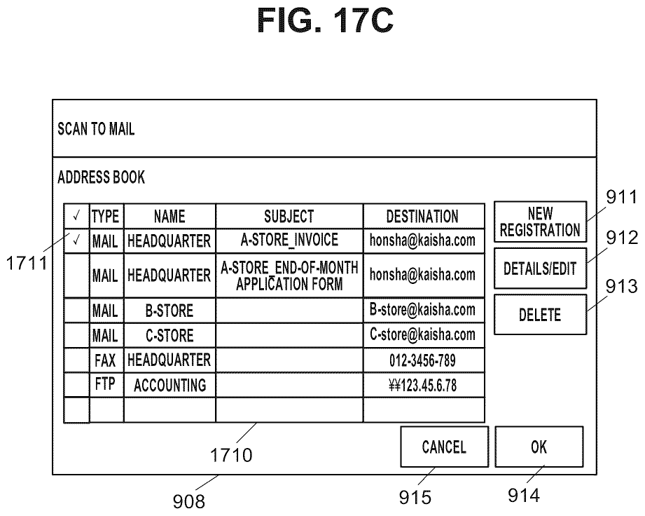

FIGS. 17A and 17B are diagrams illustrating examples of the email destination registration screen 715 displayed by the image processing apparatus 100 in step S505 in a case where email is selected by the user during destination type selection in step S504 in FIG. 5.

The email destination registration screen 715 illustrated in FIG. 17A includes a subject field 1700 for designating a subject to be set for email transmission. In the example illustrated in FIG. 17A, “A-store_invoice” is set in the subject field 1700 in steps S505 to S507.

In cases where the register button 718 is pressed by the user at this time, the image processing apparatus 100 detects the operation of pressing the register button 718 in step S508. In response to the operation, the image processing apparatus 100 registers the destination information entered in the name 716, a subject 1700, and the email address 717 in the address book in step S509, and as illustrated in FIG. 17B, the image processing apparatus 100 displays the destination registration screen 700 on the operation unit 102 in step S510.

On the destination registration screen 700 according to the present exemplary embodiment, a new subject 1701 is added to the registered destinations 701 as illustrated in FIG. 17B. For example, destinations 1702 and 1703 are associated with the same destination email address “honsha@kaisha.com”, but different subjects “A-store_invoice” and “A-store_end-of-month application form” are respectively set for the destinations 1702 and 1703. In cases where the destination 1702 is selected as the email destination by the user, the image processing apparatus 100 sets “A-store_invoice” as the email subject, whereas in cases where the destination 1703 is selected, the image processing apparatus 100 sets “A-store_end-of-month application form” as the email subject in step S806.

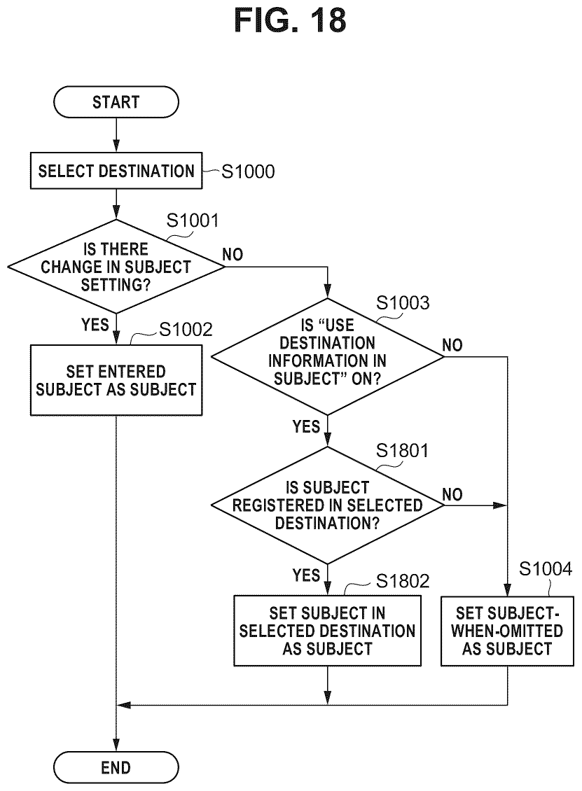

The subject setting process in step S806 according to the third exemplary embodiment will be described below with reference to FIG. 18.

FIG. 18 is a flowchart illustrating an example of the automatic subject setting process according to the third exemplary embodiment. The process illustrated in the flowchart is executed by the functions realized by the CPU 201 of the image processing apparatus 100 reading programs stored in the flash ROM 210 into the DRAM 202 and executing the read programs.

According to the third exemplary embodiment, in a case where the setting value for the “use destination information in subject” setting 1204 is ON in step S1003 (YES in step S1003), the processing proceeds to step S1801.

In step S1801, the image processing apparatus 100 determines whether a subject is registered in the selected destination. In a case where no subject is registered in the selected destination (NO in step S1801), the processing proceeds to step S1004.

On the other hand, in a case where a subject is registered in the selected destination (YES in step S1801), the processing proceeds to step S1802.

In step S1802, the image processing apparatus 100 sets the subject registered in the selected destination as the email subject. For example, in a case where a destination 1711 is selected from a destination list 1710 illustrated in FIG. 17C, since the subject of the destination 1711 is “A-store_invoice”, the image processing apparatus 100 sets “A-store_invoice” as the email subject, and the process in the flowchart is terminated.

Other steps are similar to those in the first exemplary embodiment, so that descriptions thereof are omitted.

As in the above-described process, according to the third exemplary embodiment, destination information (subject is used in the third exemplary embodiment) associated with a destination of an email is automatically set as the subject of the email for transmission of image data scanned and generated by the image processing apparatus 100 via email. In the destination book according to the present exemplary embodiment, different subjects can be associated with a single email address and registered as different destinations. Thus, the user can easily set a subject by simply selecting a destination for email transmission, making it possible to easily support filtering performed by the mail software 111 at the receiving end. For example, in the case of setting different subjects, such as “ . . . invoice”, “ . . . application form”, and “ . . . report”, destinations with information including subjects such as “invoice”, “application form”, and “report” are registered in advance, whereby a subject is set automatically simply by selecting a destination for email transmission. Thus, unlike conventional technologies, the user does not have to input a subject each time the user transmits an email, making it possible to significantly reduce the burden on the user and enhance usability.

A fourth exemplary embodiment describes a configuration that enables registration of a destination in the destination book that associates a subject entered manually by the user for transmission of an email with an email address as a destination of the email.

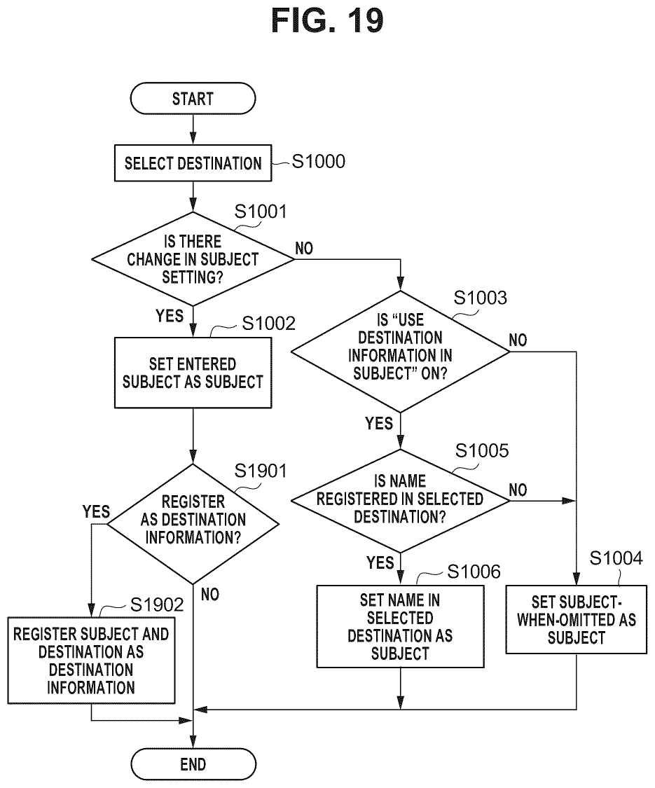

FIG. 19 is a flowchart illustrating an example of the automatic subject setting process according to the fourth exemplary embodiment. The process illustrated in the flowchart is executed by the functions realized by the CPU 201 of the image processing apparatus 100 reading programs stored in the flash ROM 210 into the DRAM 202 and executing the read programs.

According to the fourth exemplary embodiment, the processing proceeds from step S1002 to step S1901.

In step S1901, the image processing apparatus 100 prompts the user to select whether to register the destination with destination information (e.g., name) that includes the subject (character string entered manually in the subject field 1101 by the user) set in step S1002. For example, a dialog such as “Do you want to register the destination with destination information that includes the entered subject? [Yes], [No]” is displayed on the operation unit 102 to prompt the user to make a selection. In a case where the user selects not to register ([No]), i.e., a response indicating that the registration will not be performed is received (NO in step S1901), the process in the flowchart is terminated.

On the other hand, in a case where the user selects to register ([Yes]), i.e., a response indicating that the registration will be performed is received (YES in step S1901), the processing proceeds to step S1902.

In step S1902, the image processing apparatus 100 registers the subject entered in the subject field 1101 and the email address designated as the destination as destination information, with the subject as the name and the email address as the destination, in the flash ROM 210, and the process in the flowchart is terminated.

The configuration described above enables registration of the subject input by the user as the destination name in the destination book. However, it is also possible to enable registration of the subject input manually by the user as the name of the subject for email transmission in the destination book as in the third exemplary embodiment.

As described above, the subject input manually by the user for email transmission is registered as new destination information of the email destination in the destination book, making it possible to improve usability.

The exemplary embodiments make it possible to automatically set a subject suitable for the filtering process at the receiving end when transmitting image data scanned by the image processing apparatus 100 via email. Thus, unlike conventional technologies, the user does not have to input a subject each time the user transmits an email, making it possible to significantly reduce the burden on the user and enhance usability.

Configurations and content of various types of data described above are not limited to those described above, and it is clear that the various types of data may be structured with different configurations and content depending on the use or purpose of the data.

While an exemplary embodiment is described above, the present disclosure can be implemented in the form of, for example, a system, an apparatus, a method, a program, or a storage medium. Specifically, the present disclosure is applicable to a system consisting of a plurality of devices and is also applicable to an apparatus consisting of a single device.

Further, configurations formed by combining the exemplary embodiments are also encompassed within the present disclosure.

### Other Exemplary Embodiments

Further, the present disclosure is applicable to a system consisting of a plurality of devices and is also applicable to an apparatus consisting of a single device.

The present disclosure is not limited to the exemplary embodiments, and various modifications (including organic combinations of the exemplary embodiments) may be made based on the gist of the present disclosure and are not excluded from the scope of the present disclosure. Specifically, all configurations of combinations of the exemplary embodiments and modified examples thereof are encompassed within the present disclosure.

The present disclosure makes it possible to automatically set a subject suitable for the filtering process at the email receiving side when transmitting image data scanned and generated by the image processing apparatus 100 via email. Thus, unlike conventional technologies, the user does not have to input a subject each time the user transmits an email, making it possible to significantly reduce the burden on the user and enhance usability.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-001177, filed Jan. 9, 2024, which is hereby incorporated by reference herein in its entirety.

What is claimed is:

1. An image processing apparatus including a scanner, the image processing apparatus comprising:
one or more memories storing instructions; and
one or more processors capable of executing the instructions causing the image processing apparatus to:
manage one or more destinations each with a name in a destination book;
perform control to set a subject for an email to which a file including image data generated using the scanner is attached; and
transmit the email to a designated destination,
wherein the control is performed to set a name of the designated destination as the subject of the email.

2. The image processing apparatus according to claim 1,
wherein the instructions further cause the image processing apparatus to manage whether a subject setting indicating whether to use a name of a destination as a subject of an email is enabled or disabled, and
wherein, in a case where the subject setting is enabled, the control is performed to set the name of the designated destination as the subject of the email.

3. The image processing apparatus according to claim 2, wherein, in a case where the subject setting is disabled, the control is performed to set a predetermined subject managed in advance in the image processing apparatus as the subject of the email.

4. The image processing apparatus according to claim 1, wherein, in a case where an operation of inputting a subject for the email is performed by a user, the control is performed to set the input subject as the subject of the email instead of setting the name of the designated destination as the subject of the email.

5. The image processing apparatus according to claim 4, wherein, in a case where an operation of inputting a subject for the email is performed by a user, the control is further performed to register the input subject as the name of the destination of the email in the destination book.

6. The image processing apparatus according to claim 1, wherein the destination book assigns different names to a single email address to manage each name as a separate destination.

7. The image processing apparatus according to claim 1, wherein the destination managed by the destination book includes a group destination including a plurality of destinations.

8. A method for controlling an image processing apparatus including a scanner and a management unit configured to manage one or more destinations each with a name in a destination book, the method comprising:
performing control to set a subject for an email to which a file including image data generated using the scanner is attached; and
transmitting the email to a designated destination,
wherein the control is performed to set a name of the designated destination as the subject of the email.
